(19) United States
(12) Patent Application Publication
(10) Pub. No.: US 2010/0309140 A1
(43) Pub. Date: Dec. 9, 2010

(54) CONTROLLING TOUCH INPUT MODES

(75) Inventor: Daniel Widgor, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/479,031

(22) Filed: Jun. 5, 2009

(51) Int. Cl. G06F 3/041

(52) U.S. Cl. 345/173

(57) ABSTRACT

Embodiments related gesture-based inputs made via multi-touch display are disclosed. One disclosed embodiment comprises a computing device configured to detect a modal touch input on a multi-touch display, the modal touch input having a geometrically defined posture. In response, the computing device is configured to set a selected touch input mode based on the posture of the first modal touch input, the touch input mode representing a relational correspondence between a first set of functional touch inputs and a first set of functions. The computing device is further configured to detect a functional touch input on the multi-touch display, to determine the relational correspondence between the functional touch input and an associated function included in the set of functions based on the touch input mode, and to modify the multi-touch display based on the associated function.

### BACKGROUND

Computing devices may be configured to accept input via different types of graphical user interfaces. For example, some graphical user interfaces utilize a pointer-based approach in which graphics, such as buttons, scroll bars, etc., may be manipulated via a mouse, touch-sensitive display, or other such input device to make an input. More recent development of multi-touch displays (i.e. touch-sensitive displays configured to detect two or more temporally overlapping touches) have permitted the development of graphical user interfaces that utilize gestural recognition to detect inputs made via touch gestures. This may help to provide for a natural and intuitive interaction with graphical content on a graphical user interface.

However, in some use environments, a set of gestural inputs recognizable by a multi-touch computing device gesture detection system may be smaller than a set of input actions to which it is desired to map input gestures. In other words, a number of input functions performed by a computing device may exceed a number of intuitive and easily distinguishable user input gestures desirable for use with a graphical user interface.

### SUMMARY

Accordingly, various embodiments related to gesture-based inputs made via multi-touch display are disclosed. For example, one disclosed embodiment provides a computing device configured to detect a first modal touch input on a multi-touch display, wherein the first modal touch input has a first geometrically defined posture. In response, the computing device is configured to set a selected touch input mode based on the posture of the first modal touch input, the touch input mode representing a relational correspondence between a first set of functional touch inputs and a first set of functions. The computing device is further configured to detect a functional touch input on the multi-touch display, to determine a relational correspondence between the functional touch input and an associated function included in the set of functions based on the touch input mode, and to modify the multi-touch display based on the associated function.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic depiction of an embodiment of a computing device including a multi-touch display.

FIGS. 2-4 illustrate example embodiments of modal touch inputs performed on a multi-touch display device.

FIG. 5 illustrates an embodiment of a method of detecting a geometric shape of a modal touch input.

FIGS. 6-7 show example embodiments of a modal touch input and a functional touch input performed on a multi-touch display device.

FIGS. 8-9 show other example embodiments of a modal touch input and a functional touch input performed on a multi-touch display device.

FIGS. 10-11 shows yet other example embodiments of a modal touch input and a functional touch input performed on a multi-touch display device.

FIG. 12 shows a process flow depicting an embodiment of a method for operating a multi-touch display device.

### DETAILED DESCRIPTION

Various embodiments are disclosed herein that are related to the use of modal touch inputs to signify how functional touch inputs are to be interpreted by a computing device. In this manner, a smaller set of recognized functional touch inputs may be mapped to a larger set of actions caused by the touch inputs. Prior to discussing these embodiments, an embodiment of an example computing device including a multi-touch display is described.

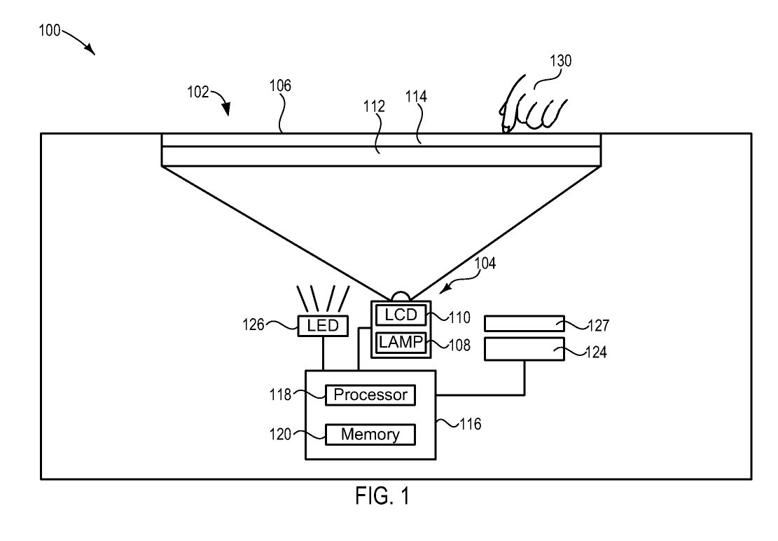

FIG. 1 shows a schematic depiction of an embodiment a surface computing device 100 comprising a multi-touch display 102. The multi-touch display 102 comprises a projection display system having an image source 104, and a display screen 106 onto which images are projected. While shown in the context of a projection display system, it will be appreciated that the embodiments described herein may also be implemented with other suitable display systems, including but not limited to liquid crystal display (LCD) systems.

The image source 104 includes a light source 108 such as a lamp (depicted), an LED array, or other suitable light source. The image source 104 also includes an image-producing element 110 such as the depicted LCD (liquid crystal display), an LCOS (liquid crystal on silicon) display, a DLP (digital light processing) display, or any other suitable image-producing element.

The display screen 106 includes a clear, transparent portion 112, such as sheet of glass, and a diffuser screen layer 114 disposed on top of the clear, transparent portion 112. As depicted, the diffuser screen layer 114 acts as a touch surface. In other embodiments, an additional transparent layer (not shown) may be disposed over diffuser screen layer 114 as a touch surface to provide a smooth look and feel to the display surface. Further, in embodiments that utilize a LCD panel rather than a projection image source to display images on display screen 106, the diffuser screen layer 114 may be omitted.

Continuing with FIG. 1, the multi-touch display 102 further includes an electronic controller 116 comprising a processor 118 and a memory 120. It will be understood that memory 120 may comprise code stored thereon that is executable by the processor 118 to control the various parts of computing device 100 to effect the methods described herein.

To sense objects placed on display screen 106, the multi-touch display 102 includes one or more image sensors, depicted schematically as image sensor 124, configured to capture an image of the entire backside of display screen 106, and to provide the image to electronic controller 116 for the detection of objects appearing in the image. The diffuser screen layer 114 helps to avoid the imaging of objects that are not in contact with or positioned within a few millimeters of display screen 106. Because objects that are close to but not touching the display screen 106 may be detected by image sensor 124, it will be understood that the term “touch” as used herein also may comprise near-touch inputs.

The image sensor 124 may include any suitable image sensing mechanism. Examples of suitable image sensing mechanisms include but are not limited to CCD and CMOS image sensors. Further, the image sensing mechanisms may capture images of display screen 106 at a sufficient frequency to detect motion of an object across display screen 106 to thereby allow the detection of touch gestures. While the embodiment of FIG. 1 shows one image sensor, it will be appreciated that more than one image sensor may be used to capture images of display screen 106.

The image sensor 124 may be configured to detect light of any suitable wavelength, including but not limited to infrared and visible wavelengths. To assist in detecting objects placed on display screen 106, the image sensor 124 may further include an illuminant 126 such as one or more light emitting diodes (LEDs) configured to produce infrared or visible light to illuminate a backside of display screen 106. Light from illuminant 126 may be reflected by objects placed on display screen 106 and then detected by image sensor 124. Further, an infrared band pass filter 127 may be utilized to pass light of the frequency emitted by the illuminant 126 but prevent light at frequencies outside of the band pass frequencies from reaching the image sensor 124, thereby reducing the amount of ambient light that reaches the image sensor 124.

While described herein in the context of an optical touch-sensitive system, the embodiments described herein also may be used with any other suitable type of touch-sensitive input system and with any suitable type of computing device. Examples of other such systems include, but are not limited to, capacitive and resistive touch-sensitive inputs. Further, while depicted schematically as a single device that incorporates the various components described above into a single unit, it will be understood that the multi-touch display 102 also may comprise a plurality of discrete physical parts or units connected as a system by cables, wireless connections, network connections, etc. It will be understood that the term “computing device” may include any device that electronically executes one or more programs, such as a user interface program. Such devices may include, but are not limited to, personal computers, laptop computers, servers, portable media players, hand-held devices, cellular phones, and microprocessor-based programmable consumer electronic and/or appliances.

FIG. 1 also depicts a hand 130 with a finger placed on display screen 106. Light from the illuminant 126 reflected by the finger may be detected by image sensor 124, thereby allowing the touch of the finger to be detected on the screen. While shown in the context of a finger, it will be understood that any other suitable manipulator or manipulators (e.g. one or more styluses, paint brushes, etc.) may be used to interact with computing device 100.

FIGS. 2-10 illustrate various embodiments of modal and functional touch inputs that may be made via a graphical user interface 200 presented on the multi-touch display 102. The term “modal touch input” as used herein signifies a touch input that is used to control an interpretation of other touch inputs, and the term “functional” touch input signifies a touch input configured to cause a specific user interface function to be performed in response to the input. First, FIGS. 2-4 illustrate example embodiments of a modal touch input. In each of the depicted embodiments, the modal touch input 202 is shown as being performed via a hand 203 of a user. To initiate the modal touch input 202 the user may apply the hand 203 to the multi-touch display 102, either via contact with the multi-touch display 102 or, in some embodiments, in close proximity to the multi-touch display 102 In response, a touch input mode is selected based on the posture of the modal touch input, wherein the touch input mode defines a relational correspondence between a first set of functional touch inputs and a first set of input functions that may be performed by the computing device in response to detecting the functional touch inputs.

In some embodiments, the modal touch input 202 may be transient such that cessation of the selected touch input mode occurs when the modal touch input is lifted from the multi-touch display 102. In other embodiments, the modal touch input may be persistent, such that the selected touch input mode is sustained after the modal touch input is lifted from the multi-touch display 102.

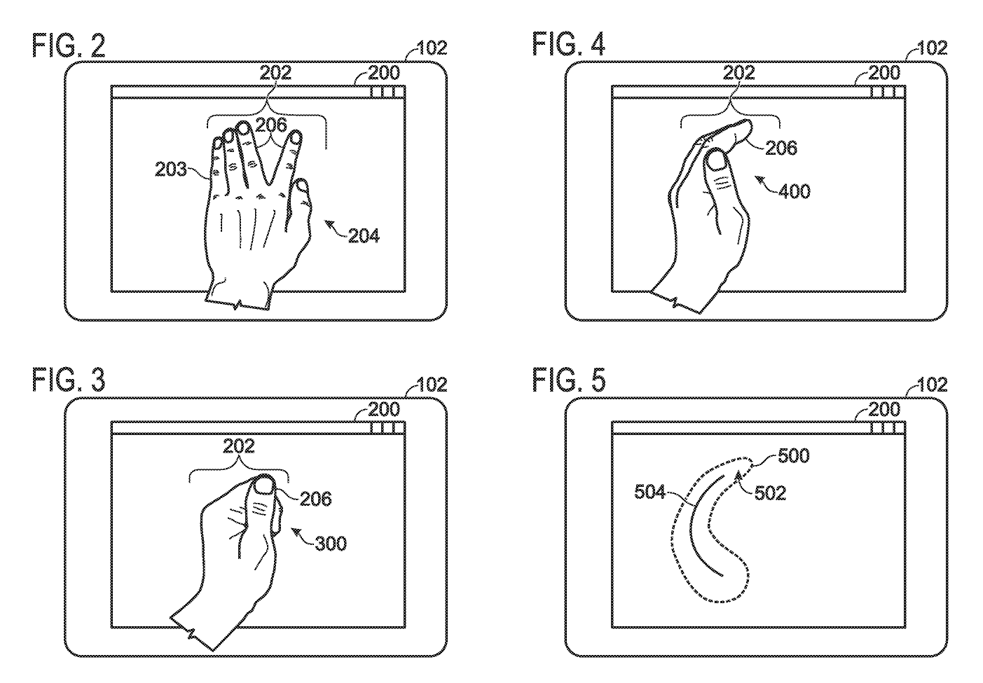

In some embodiments, a single recognized modal touch input may be utilized to toggle a touch input mode between two modes. In other embodiments, a plurality of modal touch inputs may be utilized such that each represents a different touch input mode. In either case, each modal touch input may have a geometrically defined posture. For example, FIG. 2 illustrates an example of a modal touch input in the form of a “spread” posture 204 in which the hand 203 is applied to the multi-touch display 102 palm side down and a portion of the digits 206 are spaced apart. FIG. 3 illustrates another example of a modal touch input in the form of a “fist” posture 300 in which the hand is applied to the multi-touch display 102 where the digits 206 are pressed together in the form of a fist. FIG. 4 illustrates another example of a modal touch input in the form of a “curved” posture 400 in which a side of the hand is applied to the multi-touch display 102 such that the digits 206 form a curved or “C” shape. Each posture may be defined by one or more geometric parameters, including but not limited to a set of a plurality of coordinates that defines a specified shape, a total surface area of a touch input, a relative position of two or more touch points, an angle formed via two intersecting lines having line ends delineated by touch points, etc. It will be appreciated that any other suitable posture or postures may be used, and that the depicted postures in FIGS. 2-4 are shown for the purpose of example and are not intended to be limiting.

As mentioned above, a selected touch input mode may be set based on the detected posture of the modal touch input 202. In some embodiments, the selected touch input mode may be set irrespective of the location of the modal touch input on the multi-touch display. In other embodiments, a specific sub-region of the display may be used for making the modal touch input.

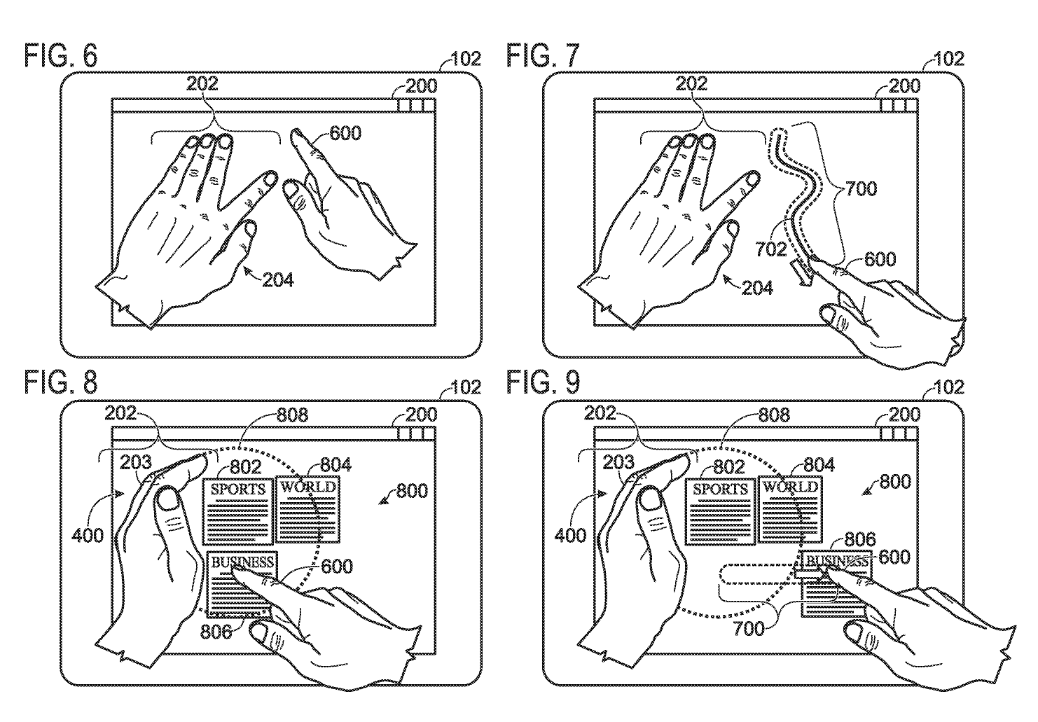

The selected touch input mode may affect an interpretation of subsequent touch inputs performed on the multi-touch display 102. For example, in some embodiments, the modal touch input may allow selection of a touch input mode from possible modes such as a drawing mode, an alpha-numeric input mode, an element selection mode, a deletion mode, and a drag and drop mode. By utilizing such touch input modes, a selected functional touch input gesture may cause different functions to be performed, depending upon the touch input mode. Details regarding various example touch inputs modes are discussed in greater detail herein with regard to FIGS. 6-11.

The selection of a touch input mode based upon a detected modal touch input may be performed in any suitable manner. For example, the selected touch input mode may be determined by mapping the shape of the modal touch input to a recognized modal touch input shape. This may involve, for example, defining a shape of the gesture as a line contained within the gesture or as an outline of the gesture, normalizing a size, aspect ratio, or other parameter of the determined line or outline, and/or comparing the determined line to lines that define one or more recognized postures to determine if the detected posture matches any recognized modal touch inputs within an allowable tolerance range. It will be appreciated that the above-described method of mapping a detected modal touch input to a recognized input is presented for the purpose of example, and is not intended to be limiting in any manner, as any other suitable method may be used.

FIG. 5 illustrates an example technique for matching a detected touch input to a recognized modal touch input. A footprint 500 of a modal touch input having a C-shaped “curved” posture is illustrated on the multi-touch display 102. First, a shape 504 of the posture may be detected, for example, by determining a line that passes through the “center” of the gesture along the length of the gesture. Then, an overall size of this line may be normalized (e.g. by length), and compared to one or more recognized modal touch gestures that are also defined by a linear shape. It may then be determined that a modal input was made if the detected shape matches any recognized shape within a predetermined statistical deviation. It will be understood that this method of matching a detected modal touch gesture to a recognized modal touch gesture is presented for the purpose of example, and is not intended to be limiting in any manner.

As mentioned above, each touch input mode may represent a relational correspondence between a set of functional touch inputs (e.g. gestures) and a set of functions performed by a computing device in response to the functional touch inputs. In this manner, a number of computing device functions implemented via touch input may be increased for an arbitrary number of recognized touch gestures. In some embodiments, a data structure such as a lookup table may be used to determine the relational correspondence between a set of functional touch inputs and a set of functions. However, it will be appreciated that any other suitable methods may be used to determine the relational correspondence between the first set of functional touch inputs and the first set of functions.

FIGS. 6-11 illustrate various example implementations of modal and functional touch inputs. Although each of the depicted examples show bi-manual inputs comprising temporally overlapping modal and functional inputs, it will be appreciated that the modal touch input 202 and the functional touch input 700 may be implemented at succeeding time intervals in other embodiments. Likewise, while the modal and functional touch inputs are illustrated as single-touch inputs, it will be understood that either or both may comprise multi-touch inputs in other embodiments.

As mentioned above, a touch input mode selected via a modal touch input may represent any suitable mode of use. FIGS. 6-7 illustrate the use of the modal touch input 202 and the functional touch input 700 to select and use a “drawing” mode. Referring first to FIG. 6, the modal touch input 202 is illustrated in the “spread” posture 204. This is shown in FIG. 7 as causing the selection of a “drawing” touch input mode in which the user's other hand may be used to create graphics on the multi-touch display 102. In this way, the multi-touch display 102 is modified by the detected functional touch input in a manner (e.g. by displaying a line along a path of the gesture) based on the selected touch input mode set by the modal touch input.

An alpha-numeric touch input mode (not shown) may be used in a similar manner as the drawing mode, in that a user may draw alpha-numeric characters on the display with a touch gesture. The alpha-numeric mode further may be configured to recognize such character and utilize the characters as text input.

FIGS. 8-9 illustrate another example of a use of the modal touch input 202 and functional touch input 700. The modal touch input 202 is shown in the “curved” posture 400, and is depicted as being made next to graphical content 800 in the form of text that lists categories of news (802, 804, and 806), for example, from a news website. As shown in FIG. 8, in response to the curved modal touch input, an area 808 of the graphical content 800 may be highlighted and separated into distinct selectable elements responsive to implementation the element selection mode. For example, individual elements within the highlighted area may be copied, pasted, moved, or otherwise manipulated separately from the other elements when in the element selection mode. In some embodiments, the highlighted area 808 of content may correspond to the shape and/or size of the posture of the modal touch input 202, while in other embodiments, the highlighted area 808 of content my have any other suitable size and/or shape.

Next referring to FIG. 9, a functional touch input 700 in the element selection mode is initiated by touching a digit 600 to the multi-touch display 102. A relational correspondence between the detected functional touch input and an associated function is then determined. In the depicted embodiment, the single touch input is determined to correspond to a drag and drop function, as opposed to the “draw” function illustrated in FIG. 7. Therefore, as depicted in FIG. 9, the graphical element 806 over which the initial functional touch input was made is moved in correspondence with movement of the functional touch input. It will be appreciated that, in other embodiments, the depicted modal and functional touch inputs may be mapped to any other suitable function or functions. A drag-and-drop use mode may be used in a similar manner, but instead may enable the movement of an entire selected object, rather than the movement of individual sub-objects contained within the object.

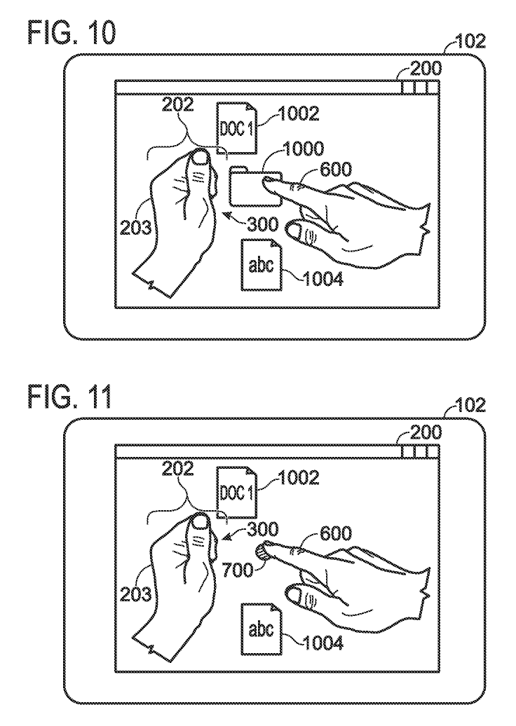

Next, FIGS. 10-11 show another example use of a modal touch input 202 and a functional touch input 700 with multi-touch display 102. In this example, the modal touch input 202 is depicted in the “fist” posture 300, which is configured to set a “delete” touch input mode. A file icon 1000 and two documents (1002 and 1004) are shown presented on the multi-touch display 102 for the purpose of illustration. A user may delete selected content by first making the “fist” posture 300 with a hand on the display, and then making a functional touch input over an item that the user wishes to delete. Upon detecting the touch inputs, a relational correspondence between the functional touch input 700 and an associated touch function is determined. Specifically, in this embodiment the functional touch input is determined to correspond to a deletion function. Therefore, as depicted in FIG. 11, a graphical element (i.e. file icon 1000) located directly below the functional touch input 700 is deleted based on the functional touch input. It will be appreciated that these specific modal and functional touch inputs are described for the purpose of example, and are not intended to be limiting in any manner.

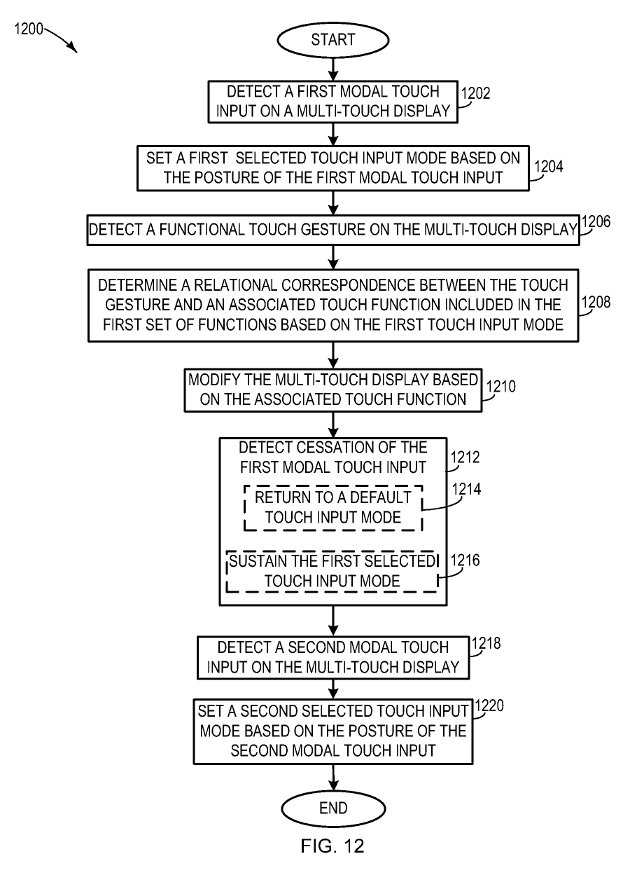

FIG. 12 illustrates an embodiment of a method 1200 for managing input on a multi-touch display. The method 1200 may be implemented using the hardware and software components of the systems and devices described above, and/or via any other suitable hardware and software components.

The method 1200 comprises, at 1202, detecting a first modal touch input on a multi-touch display, the first modal touch input having a geometrically defined posture. In some embodiments, detecting a first modal touch input may include detecting a first hand on the multi-touch display. The first modal touch input may be a single touch (i.e. contiguous surface area) or a multi-touch input, and may be static or dynamic (e.g. gesture based). Method 1200 next comprises, at 1204, setting a first selected touch input mode based on the posture of the first modal touch input, the first touch input mode representing a relational correspondence between a first set of functional touch inputs and a first set of functions. In some embodiments, the first touch input mode may be selected based on predefined geometric tolerances applied to the geometrically defined posture of the first modal touch input. However, it will be appreciated that other suitable techniques may be used to select the first touch input mode. Likewise, in some embodiments, the first selected touch input mode may be set irrespective of the location on the display at which the first modal touch input is made, while in other embodiments, the modal touch input is made in a defined sub-region of the multi-touch display.

The method next comprises, at 1206, detecting a functional touch gesture on the multi-touch display. In some embodiments, detecting a functional touch gesture may include detecting a gesture made by a user's other hand (i.e. the hand other than that which made the modal touch gesture) on the multi-touch display. In some embodiments, the first modal touch input and the functional touch input may be detected at overlapping time intervals, while in other embodiments, they may be detected at non-overlapping time intervals.

Method 1200 next comprises, at 1208, determining a relational correspondence between the functional touch input and an associated function in the first set of functions, and then at 1210, modifying the multi-touch display based on the associated function. For example, where the selected touch input mode is a drawing mode, the multi-touch display may be modified to display a line or other graphic based upon the path of a touch gesture received. Likewise, where the selected touch input mode is an alphanumeric mode, the multi-touch display may be modified to display characters and/or numbers drawn via a touch input, and to recognize those characters and/or numbers as text input. Where the selected touch input mode is a drag-and-drop mode, the multi-touch display may be modified to show movement of a graphical user interface object in correspondence with the movement of the functional touch input. Where the selected touch input mode is an element selection mode, the multi-touch display may be modified to show movement (or other action) of a sub-object of a larger graphical user interface object. Additionally, where the selected touch input mode is a “delete” mode, the multi-touch display may be modified to remove a selected item from display, representing the deletion of the item. It will be understood that these examples of modifications of the multi-touch display are described for the purpose of example, and are not intended to be limiting in any manner.

Next, method 1200 comprises, at 1212, detecting a cessation of the modal touch input, e.g. a lifting of the input from the multi-touch display. In different embodiments, different actions may be taken in response to detecting the cessation of a modal touch input. For example, as shown at 1214, in some embodiments, a touch input mode may return to a default mode. In other embodiments, as shown at 1216, the selected touch input mode is sustained until a second modal touch input is detected, at which time the touch input mode is changed to that which corresponds to the touch posture detected in the second modal touch input.

Next, method 1200 comprises, at 1218, detecting a second modal touch input on a multi-touch display, the second modal touch input having a geometrically defined posture that is different than that of the first modal touch input. Then, at 1220, method 1200 comprises setting a second selected touch input mode based on the posture of the second modal touch input, the second touch input mode representing a relational correspondence between a second set of functional touch inputs and a second set of functions. In this manner, a functional gesture may be used in different manners depending upon the modal touch input that is made during (or preceding) the functional touch gesture.

The above-described embodiments allow a user to adjust the functionality of a touch gesture depending upon a selected touch input mode, thereby expanding a number of touch functions which may be enabled via a set of touch input gestures. It will be understood that the example embodiments of modal and functional inputs disclosed herein are presented for the purpose of example, and that any suitable modal touch input may be used to select any set of functional inputs.

It will be further understood that the term “computing device” as used herein may refer to any suitable type of computing device configured to execute programs. Such computing device may include, but are not limited to, the illustrated surface computing device, a mainframe computer, personal computer, laptop computer, portable data assistant (PDA), computer-enabled wireless telephone, networked computing device, combinations of two or more thereof, etc. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that a computer-readable storage medium may be provided having program instructions stored thereon, which upon execution by a computing device, cause the computing device to execute the methods described above and cause operation of the systems described above.

The embodiments of multi-touch displays depicted herein are shown for the purpose of example, and other embodiments are not so limited. The specific routines or methods described herein may represent one or more of any number of processing strategies such as event-driven, interrupt-driven, multi-tasking, multi-threading, and the like. As such, various acts illustrated may be performed in the sequence illustrated, in parallel, or in some cases omitted. Likewise, the order of any of the above-described processes is not necessarily required to achieve the features and/or results of the example embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. A computing device, comprising:
a multi-touch display;
a processor; and
memory comprising code executable by the processor to:
detect a first modal touch input on the multi-touch display, the first modal touch input having a first geometrically defined posture;
set a first selected touch input mode based on the posture of the first modal touch input, the touch input mode representing a relational correspondence between a first set of functional touch inputs and a first set of functions;
detect a functional touch input on the multi-touch display;
determine the relational correspondence between the functional touch input and an associated function included in the first set of functions based on the first touch input mode; and
modify the multi-touch display based on the associated function.

2. The computing device of claim 1, further comprising code executable by the processor to set the first selected the touch input mode irrespective of a location of the first modal touch input on the multi-touch display.

3. The computing device of claim 1, further comprising code executable by the processor to detect the first modal touch input and the functional touch input at overlapping time intervals.

4. The computing device of claim 1, further comprising code executable by the processor to resume a default touch input mode after cessation of the first modal touch input.

5. The computing device of claim 1, further comprising code executable by the processor to sustain the first touch input mode after cessation of the first modal touch input.

6. The computing device of claim 1, further comprising code executable by the processor to set the first selected touch input mode based on predefined tolerances applied to the geometrically defined posture of the first modal touch input compared to a recognized modal touch input.

7. The computing device of claim 1, further comprising code executable by the processor to detect one or more of a single touch input and a multi-touch input in the functional touch input.

8. The computing device of claim 1, wherein the first selected touch input mode is one of a drawing mode, an alphanumeric mode, an element selection mode, a drag-and-drop mode, and a deletion mode.

9. The computing device of claim 1, further comprising code executable by the processor to detect a second modal touch input, the second modal touch input having a geometrically defined posture which is different than the geometrically defined posture of the first modal input, and set a second selected touch input mode based on the posture of the second modal touch input, the second selected touch input mode representing a relational correspondence between a second set of functional touch inputs and second set of functions.

10. The computing device of claim 9, further comprising code executable by the processor to detect the first modal input and the second modal input at non-overlapping time intervals.

11. A method for operating a computing device, the method comprising:
detecting a first modal touch input on a multi-touch display, the first modal touch input having a geometrically defined posture;
setting a first selected touch input mode based on the posture of the first modal touch input, the touch input mode representing a relational correspondence between a first set of functional touch inputs and a first set of functions;
detecting a touch gesture on the multi-touch display;
determining the relational correspondence between the touch gesture and an associated function included in the set of functions based on the touch input mode; and
modifying the multi-touch display based on the associated function.

12. The method of claim 11, wherein the first selected touch input mode is set irrespective of the location of the first modal touch input on the multi-touch display.

13. The method of claim 11, wherein the first modal touch input and the touch gesture are detected at overlapping time intervals.

14. The method of claim 11, further comprising detecting a cessation of the first modal touch input, and setting a default touch input mode after cessation of the first modal touch input.

15. The method of claim 14, wherein cessation of the first modal input include detecting a removal of a hand from the multi-touch display.

16. The method of claim 11, wherein detecting the first modal touch input includes detecting a first hand on the multi-touch display and detecting the touch gesture includes detecting a second hand on the multi-touch display.

17. The method of claim 11, further comprising detecting a cessation of the first modal touch input, and in response, sustaining the first selected touch input mode.

18. The method of claim 11, further comprising:
detecting a second modal touch input on the multi-touch display, the second modal touch input having a geometrically defined posture which is different than the geometrically defined posture of the first modal touch input; and
setting a second selected touch input mode based on the posture of the second modal touch input, the second selected touch input mode representing a relational correspondence between a second set of functional touch inputs and second set of functions.

19. A computing device comprising:
a multi-touch display;
a processor; and
memory comprising code executable by the processor to:
detect a modal touch input on the multi-touch display irrespective of the location of the modal touch input on the multi-touch display, the modal touch input having a geometrically defined posture;
set a first selected touch input mode based on the posture of the modal touch input, the selected touch input mode representing a relational correspondence between a set of functional touch inputs and a set of functions;
detect a touch gesture on the multi-touch display, the touch gesture and the modal touch input being detected at overlapping time intervals;
determine the relational correspondence between touch gesture and an associated function included in the set of functions based on the touch input mode; and
modify the multi-touch display based on the associated function.

20. The computing device of claim 19, further comprising code executable by the processor to resume a default touch input mode after cessation of the modal touch input.
